(19) United States
(12) Patent Application Publication
(10) Pub. No.: US 2001/0035954 A1
(43) Pub. Date: Nov. 1, 2001

(54) Method and apparatus for measuring particle size distributions using light scattering

(76) Inventors: John Richard Rahn, Sammamish, WA (US); Gyorgy Szaszvarosi, West Palm Beach, FL (US)

Correspondence Address: David P. Lhota, Stearns Weaver Miller Weissler, Alhadeff & Sitterson, P.A., 200 East Broward Boulevard, Suite 1900, Fort Lauderdale, FL, 33301, US

(21) Appl. No.: 09/803,494

(22) Filed: Mar. 10, 2001

Related U.S. Application Data
(60) Provisional application No. 60/188,278, filed on Mar. 10, 2000.

(51) Int. Cl. G01N 15/02

(52) U.S. Cl. 356/336

(57) ABSTRACT

Methods and apparatus for measuring the spatial distribution of light scattered by particles passing through the intersecting volume of two light beams, directed at right angles to each other. The sample cell design permits light to enter at right angles, making it possible to examine both low-angle and wide-angle scattering. A Fourier optical system directs a portion of the scattered light onto an array consisting of multiple photodetectors. The light impinging on the array consists of light scattered from both light beams. A computer program allows the instrument user to specify various groupings of the data values generated by the photodetectors to create a smaller number of data channels for analysis. Different grouping configurations can be generated from the same set of data values. A degaussing coil encircles a portion of the flow path to aid in dispersing magnetized particles. A device for obtaining the diameter distributions of high-aspect ratio particles (fibers) is described.

### CROSS REFERENCE TO RELATED APPLICATIONS

This application claims the benefit of provisional application Ser. No. 60/188,278 filed Mar. 10, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to methods and systems for measuring the size distribution of particles using scattered light, and more particularly, to unique light scattering methods and systems for measuring the size distribution of an ensemble of particles by simultaneously impinging a sample cell with a plurality of intersecting light beams generated from a single light source and measuring the angles and intensities of the light scattered therefrom. The invention further relates to a system and method for binning photooptical detector measurements into one or more configurations, employing a degaussing material in the beam flow path to disperse magnetic particles and obtaining diameter distributions of high-aspect ratio particles, i.e. fibers.

2. Description of the Background Art

Many industries require accurate information pertaining to the size distribution of various powder-like substances. In order to properly evaluate the performance of small particulates, it is important to accurately measure particle size distribution. One method utilized in the prior art for determining particle size distribution is a light scattering technique, wherein a particle sample is suspended in a measurement sample volume containing a liquid and illuminated with a forward projected light source, as shown in FIG. 1. An array of sensors measures the intensities of light scattered from the laser beam by the particles at various angles around the sample volume. The results of the measurement are then used to calculate a light scattering function and particle size distribution based on Mie's scattering theory or Fraunhofer's diffraction theory. This method and similar methods known typically cover a single scattering mode or signature and impinge a sample cell with a single, low angle light projection.

It is known that the precision of particle size distribution measurements improves with an increase in the angular region of detectable scattered light. Therefore, some systems known might impinge a cell with low and high angle light projections generated from different light sources. In addition, more accurate measurements are sometimes possible by providing photosensors that detect sideward-scattered light, i.e. at ninety degrees (90°) and angles greater than ninety degrees (90°). However, the intensity of scattered light decreases with an increase in the scattering angle and decreases dramatically for large scattering angles, i.e., angles reaching ninety degrees (90°). Since the intensity of scattered light is too low for accurate detection at large scattering angles (90°), the use of additional photosensors, regardless of the arrangement, does not solve the problem. Consequently, a system capable of increasing the intensity of light scattered at larger angles would be well received.

In addition, multiple light scattering modes should be taken into account to accurately compute particle size distribution. Multiple light scattering signatures in the prior art are primarily predicated on computing probabilities of possible multiple scattering events rather than actually generating multiple events. While some methods in the prior art may generate multiple light scattering events, it is done using multiple light sources rather than a single light source, which creates unreliable results as it is difficult to distinguish the light sources. A single light source capable of producing multiple light scattering events would provide more reliable results and would be well received.

In the prior art, a beam of monochromatic light, typically from a laser and with a wavelength in the visible range (400-750 nanometers), interrogates the particles as they pass through it. When the light interacts with the particles, it is deflected from its path in a manner that may be described by Mie's theory of light scattering (Mie, 1908). If the particle diameters are sufficiently large, or their index of refraction sufficiently greater than the surrounding medium, the interaction may be adequately described using Fraunhofer's theory of light diffraction (Fraunhofer, 1817). For many materials, a diameter greater than approximately 10 times the wavelength of the interrogating light is sufficient to justify the use of Fraunhofer's equation. A portion of the scattered light is collected by a lens and focused onto a set of detectors. The angle of the scattered light can be determined from the position of the detectors with respect to the center of the path of the unscattered light beam. Fraunhofer's and Mie's theories of diffraction both predict that for large particles the light is scattered within a small range of angles close to 0°, while for small particles it is scattered over a broad range of angles.

One embodiment of the prior art is the CILAS model 1064 marketed by Commpagnle Industrielle des Lasers. In this embodiment, the light is scattered from two or more non-parallel independent light source beams measured sequentially, but not simultaneously, from two pulsed lasers placed at angles to each other. This arrangement requires two sets of lasers and associated power sources, in addition to a means of synchronizing the lasers such that scattering by the different light sources can be distinguished from one another. This embodiment also includes a detector geometry, described by Cornillault in U.S. Pat. No. 4,274,741, consisting of photosensitive elements whose size and positions are immutably fixed with respect to the optical axis.

In another embodiment of the prior art, as described in U.S. Pat. No. 5,212,393 by Togawa et al., the sample cell design includes a beveled comer, permitting light scattered at large angles to pass through the windows at near-normal angles.

The prior art also discloses a two-dimensional charge-coupled device (CCD) in U.S. Pat. No. 5,576,827. This device purports to permit the acquisition of a wide range of scattering angles by rotating a laser about the detector array. The beam position and light intensity distributions are determined by successive measurements, at different rotation angles and for different integration times.

Various other methods for measuring particle size distribution are taught in the prior art, however they also fail to provide a system and method that cover multiple light scattering with a single light source. These patents include, U.S. Pat. No. 5,940,177, issued to Esser et al., discloses a Method and Apparatus for Determining the Size Distribution of Different Types of Particles in a Sample; U.S. Pat. No. 5,907,399, issued to Shirasawa et al. discloses a Particle Measurement Apparatus; U.S. Pat. No. 5,831,721, issued to Alkafeef, discloses a Method and Apparatus for Measuring Particle Size Distribution in Fluids; U.S. Pat. No. 5,621,523, issued to Oobayashi et al., discloses a Method and Apparatus for Measuring Particles in a Fluid; U.S. Pat. No. 5,561,515, issued to Hairston, discloses an Apparatus for Measuring Particle Sizes and Velocities; U.S. Pat. No. 5,619,324, issued to Harvill et al., discloses a Method for Measuring Particle Size in the Presence of Multiple Scattering; U.S. Pat. No. 5,610,712, issued to Schmitz et al., discloses a Laser Diffraction Particle Sizing Using a Monomode Optical Fiber; U.S. Pat. No. 5,576,827, issued to Strickland et al., discloses an Apparatus and Method for Determining the Size Distribution of Particles by Light; U.S. Pat. No. 5,428,443, issued to Kitamura et al., discloses a Laser Diffraction-Type Particle Size Distribution Measuring Method and Apparatus; U.S. Pat. No. 5,379,113, issued to Niwa, discloses a Particle Size Measuring Device; U.S. Pat. No. 5,212,393, issued to Togawa et al., discloses a Sample Cell for Diffraction-Scattering Measurement of Particle Size Distributions; U.S. Pat. No. 5,185,641, issued to Igushi et al., discloses an Apparatus for Simultaneously Measuring Large and Small Particle Size Distribution; U.S. Pat. No. 5,164,787, issued to Igushi et al., discloses an Apparatus for Measuring Particle Size Distribution; U.S. Pat. No. 5,125,737, issued to Rodriguez et al., discloses a Multi-part Differential Analyzing Apparatus Utilizing Light Scatter Techniques; U.S. Pat. No. 5,105,093, issued to Niwa, discloses an Apparatus for Measuring Particle Size Distribution by making Use of Laser Beam; U.S. Pat. No. 5,104,221, issued to Bott et al., discloses a Particle Size Analysis Utilizing Polarization Intensity Differential Scattering; U.S. Pat. No. 5,067,814, issued to Suzuki et al., discloses an Apparatus for Measuring Fine Particle in Liquid; U.S. Pat. No. 5,056,918, issued to Bott et al., discloses a Method and Apparatus for Particle Size Analysis; U.S. Pat. No. 4,953,978, issued to Bott et al., discloses a Particle Size Analysis Utilizing Polarization Intensity Differential Scattering; U.S. Pat. No. 4,893,929, issued to Miyamoto, discloses a Particle Analyzing Apparatus; U.S. Pat. No. 4,781,460, issued to Bott, discloses a System for Measuring the Size Distribution of Particles Dispersed in a Fluid; U.S. Pat. No. 4,676,641, issued to Bott, discloses a System for Measuring the Size Distribution of Particles Dispersed in a Fluid; U.S. Pat. No. 4,595,291, issued to Tatsuno, discloses a Particle Diameter Measuring Device; U.S. Pat. No. 4,341,471, issued to Hogg et al., discloses an Apparatus and Method for Measuring the Distribution of Radiant Energy Produced; U.S. Pat. No. 4,286,876, issued to Hogg et al., discloses an Apparatus and Method for Measuring Scattering of Light in Particle Detection; U.S. Pat. No. 4,274,741, issued to Comilaut, discloses a Device for determining the granulometric composition of a mixture of particles; U.S. Pat. No. 4,167,335, issued to Williams, discloses an Apparatus and Method for Linearizing a Volume Loading Measurement Utilizing; U.S. Pat. No. 4,134,679, issued to Wertheimer, discloses a method for Determining the Volume and the Volume Distribution of Suspended Small Particles; U.S. Pat. No. 4,052,600, issued to Wertheimer, discloses a Measurement of Statistical Parameters of a Distribution of Suspended Particles; and U.S. Pat. No. 4,037,965, issued to Weiss, discloses a Method and Optical Means for Determining Dimensional Characteristics.

U.S. Pat. No. 5,940,177 discloses a method and apparatus for determining size distributions of two different types of fluorescently stained particles by recording and analyzing the scattered light and fluorescent light and calculating and normalizing their relative particle size distributions. U.S. Pat. No. 5,907,399 discloses a particle measurement apparatus that detects the intensity of scattered light from a sample cuvette for primarily measuring blood corpuscles on a time-series basis. U.S. Pat. No. 5,831,721 discloses a method and apparatus for measuring particle size distributions in colored or opaque petroleum fluids using a partly submerged optical transceiver. U.S. Pat. No. 5,621,523 discloses a method and apparatus for measuring particles in a fluid that passes scattered light through converging lenses and a mask and impinges it on an etalon interferometer. The etalon transmits scattered light of the same wavelength as that emitted by the light source, which impinges on a photomultiplier. U.S. Pat. No. 5,561,515, discloses an apparatus for measuring particle sizes and velocities comprising a laser energy source and beam splitting, shaping and polarizing optics for forming two parallel, peripherally overlapping beams. The patents listed herein fail to disclose or suggest, individually or in combination, a system or device that adequately addresses and solves the above noted problems in the art.

The patent references found fail to disclose a method and/or apparatus that measures the spatial distribution of light scattered by particles passing through an intersecting volume of two light beams, simultaneously transmitted and directed at predetermined angles to each other, as contemplated by the instant invention. The prior art references fail to disclose a beam splitting configuration, which allows for the extraction of information regarding particle size distribution from simultaneously transmitted and reflected light beams. The prior art fails to teach a device having a means for splitting a light beam from a single source into at least two light sources and/or a means for impinging the light sources through a sample cell at predetermined angles. The prior art also does not disclose the binning feature of the instant invention or methods, software or structures that allow for changing detector geometries without changing hardware as contemplated by the invention. The prior art fails to disclose the structure and method of dispersing magnetized particles using a degaussing material as taught by the invention, or an apparatus that obtains the size characteristics, such as diameter, of elongated particles or fibers. As the prior art fails to teach or adequately address the foregoing issues, there exist a need for a method and system in the field of particle analysis capable of increasing, capturing and measuring the intensity of light scattered at larger angles to improve the accuracy of measurements and analysis derived therefrom.

### SUMMARY OF THE INVENTION

Based on the foregoing, it is a primary object of the instant invention to provide an apparatus, system and method that requires only one set of components for collecting and detecting scattered light at both high and low angles.

It is another object of the instant invention to provide a method that allows the user to choose different effective detector geometries without the need to make hardware changes.

It is a further object of this invention to provide an apparatus that permits the user to disperse magnetized particles within a liquid medium.

It is an additional object of this invention to provide an apparatus that permits the user to obtain the characteristic diameters of long, narrow particles, such as fibers.

In light of these and other objects, the instant invention determines particle size distributions of both large and small particle ensembles suspended in a flowing fluid (liquid or gas) using multiple light beams generated from a single source in a manner that obviates the use of two or more light sources, two or more detector arrays, or two or more sample cells. This is achieved by generating two or more beams from a single light source that intersect at predetermined angles within the sample cell. When the particles interact with the two beams, the resulting scattered light is collected within two or more separate angular ranges by a single lens and focused into a single detector array. A novel sample cell design can be incorporated into the invention to allow the alternate intersection angles.

The invention further comprises data analysis features and software that enable individual operators of the instrument to configure the detector geometry in the optimal manner, specific to the characteristics of the material they wish to examine, without having to make material hardware changes. This is accomplished by allowing the operator to group the signals from the individual detector elements in a manner that particular angles receive more or less weight during data analysis. Depending on the particle size and optical characteristics, certain angles may be of greater or less importance, and therefore the angular resolution and signal-to-noise ratio can have greater or lesser impact on the calculation of results. The present invention permits the operator to choose the significance of each angle for the calculation.

The use of a demagnetizer, when incorporated into the present invention, or other similar devices, will aid in dispersing powders consisting of magnetic material, such as ferrite.

An alternate embodiment is described which will permit users to determine the distribution of the diameters in a sample consisting of extremely elongated particles, such as fibers.

The characteristic sizes of particles analyzed using this method are typically between 100 nanometers and one millimeter.

### BRIEF DESCRIPTION OF THE SEVERAL VIEWS OF THE DRAWINGS

For a fuller understanding of the nature and objects of the invention, reference should be made to the following detailed description and the accompanying drawings, in which:

FIG. 1 is an illustrative view of a typical prior art particle measurement configuration.

FIG. 2 is an illustrative view of the optical components and layout configuration of the preferred embodiment of the instant invention.

FIG. 3 is a cross sectional or top view of a sample cell suitable for use in an alternative embodiment in accordance with the instant invention.

FIG. 4 is an illustrative view of the optical components and layout configuration of the instant invention employing a rotating sample cell in accordance with an alternative embodiment of the instant invention.

FIGS. 5A-5D are a flow diagram with variable definitions, illustrating the software to be used for editing the binning of the pixels in accordance with the preferred embodiment of the instant invention.

FIG. 6 is an illustrative view of one scheme for binning the pixels.

FIGS. 7A-7B are a diagram view of the method for binning the pixels in accordance with the preferred embodiment of the instant invention.

FIG. 8 is a top view of a polarizer mount for a rotating sample holder.

### DETAILED DESCRIPTION OF THE PREFERRED EMBODIMENTS

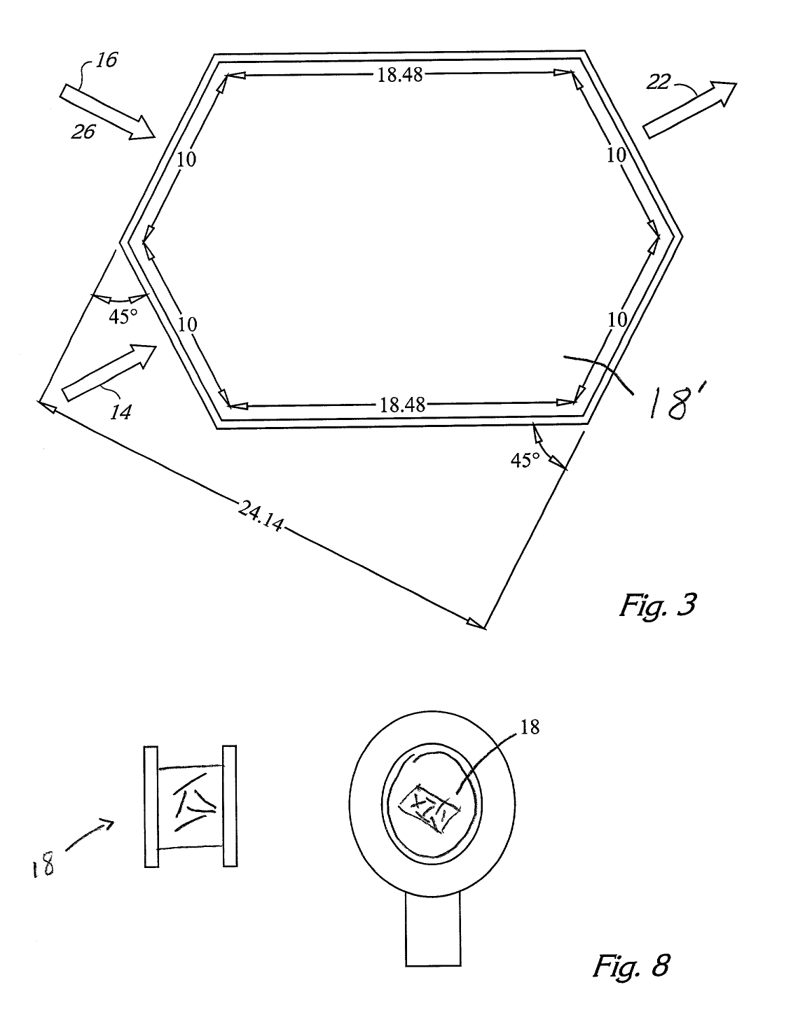

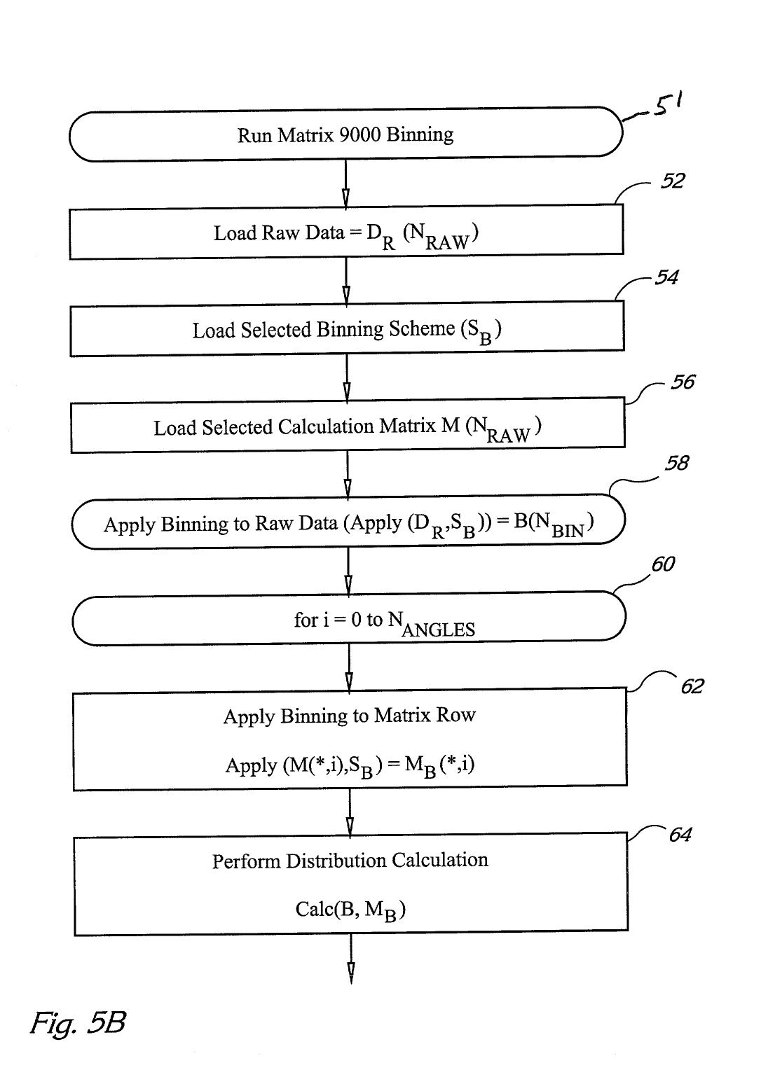

With reference to the drawings, FIG. 2-8 depict the preferred and alternative embodiments of the instant invention, which is generally referenced by numeric character 10. With reference to FIG. 2, the system of the instant invention provides a particle size analysis system 10, constructed in accordance with the invention, for measuring the size distribution of particles 4 suspended in a fluid 6 and contained in a sample cell 18, comprising a single light source 3, lenses 5, beam spitter 12, sample cell 18, mirrors 19, fourier lens 20, photodector 24 having detector elements 25, and software 50 for binning/grouping the detectors 25 into bins of pixels; performing matrix calculations and other processes related to analyzing the sample. In an alternative embodiment of the system 10, the sample cell may rotate, as shown in FIG. 4.

The light source 3 provides a light that is directed by lenses 5 to form light beam 11. The beam 11 can be a substantially parallel beam of monochromatic light, generated by a conventional light source including a laser and beam expander of known design and construction. If a laser is used, it can be a helium-neon laser with a nominal 0.5 milliwatt polarized output. The laser can be of the type manufactured by Uniphase Corporation and marketed as Part No. 1108P. The beam expander can consist of two convex or plano-convex lenses, arranged in a fashion compatible with enlarging the beam diameter.

Referring to FIG. 2, beam 11 is divided by a beamsplitter 12. The transmitted portion of the beam 14 proceeds in the same direction as before, and the reflected portion 16 is redirected along a separate path. The beamsplitter 12 can be, for example, a neutral-density filter with an optical density of 2.0, marketed by Andover Corporation as part no. 200FN52-25 or Thorlabs, Inc. as Part No. ND20B. Such a filter 12 transmits approximately one percent of the incident light and reflects approximately 55 percent of the incident light. Thus, the redirected beam 16 may be roughly 55 times more intense than the directly transmitted beam 14. The beamsplitter 12 is tilted away from the optical axis by, for example, an angle close to 17 degrees. In the present embodiment of the invention, this redirected beam 16 is reflected from two mirrors 19 in such a way that within the sample cell 8 the beam 16 intersects the transmitted beam 14 at approximately a 90-degree angle. In an alternative embodiment, the angles may vary.

The intersection of the transmitted beam 14 and the reflected beam 16 occurs within the sample cell 18. The sample sell 18 may be a quartz flow cell, open at two ends and with an antireflection coating and a high quality polish on four sides. Such a cell is available from Starna Cells as part no. 46F-Q-10/AR. A beam dump 15, consisting of a non-reflective material, such as black Delrin or rubber, is pressed onto the outside of the side of the cell opposite to the side through which the beam 16 enters. Some of the scattered light 22 is captured and focused by the Fourier lens 20 on to the detector 25. The Fourier lens 20 may be of the piano-convex type, with a 1.5″ diameter, a focal length of approximately 120 mm, and an antireflection coating. Such a lens can be obtained from OptoSigma Corporation as part no. 011-2480-A55. Alternatively, it may a plano-convex lens with an axial index gradient, a 2″ diameter, a 120 mm focal length and an antireflection coating. This lens is available from LightPath Technologies, Inc. as part no. GPX-50-120-BBI.

The scattered light 22 collected by the Fourier lens 20 consists of light scattered from the same ensemble of particles 4, but the scattering is induced simultaneously by both beams 14 and 16. As a result of the intersecting light 14, 16 in the sample cell, the light scattered is known to be from a single source, can be more readily analyzed and results in light being scattered in a manner that allows more capturing and accurate results.

After being scattered from the particles 4, the collected light 22 is focused by the Fourier lens 20 onto an array of photodetector elements 24. This detector can be, for example, an N-MOS (normal metal oxide semi conducter) linear imaging sensor, produced by Hamamatsu Corporation as part no. S3903-1024Q.

The collected light 22 reaching the photodetector 24 is equal to the sum of the light scattered into the lens 20 and collected due to beams 14 and 16. In the preferred embodiment, the detector elements 25 of the array 24 form a line parallel to the plane defined by the paths of the two beams 14 and 16. For light 22 scattered into the jth detector element 25 of the photodetector 24, the intensity for the embodiment described will be approximately Ij=Iscan(Ø)+rIscan(90+Ø) where Ø is the angle between the jth detector element 25 and the intersection of the Fourier lens 20 with the optical axis, Iscan(Ø) is the intensity of light scattered at an angle Ø as predicted by Mie's theory of diffraction, and r is the ratio between beams 14 and 16 (r equals approximately 55 in the present embodiment). If the Fourier lens 20 has a focal length f and the jth detector element 25 is located a distance hj from the optical axis then Ø=arctan(h/f)

In the preferred embodiment, the maximum value of Ø is approximately 12°, and the minimum is approximately around 0.1-0.15°. This minimum angle is determined by the position at which the combination of the unscattered laser beam 14 and the scattered light 22 causes the detector elements 25 to reach their saturation limits. However, this value can be reduced by cementing an absorptive neutral-density filter 26 to the detector array 24 so that it covers that portion of the detecting area near the point where the beam 14 hits the detector 24. Such a filter is available from, for example, Andover Corporation, and sold as part number 300ABND-50S.

If a filter is not used, the scattered light 22 reaching the detector array 24 consists of light scattered at angles in the range 0.1°-12° (due to beam 14) and in the range 90.1°-102° (due to beam 16). If the absorptive neutral-density filter 26 is used, then the angular range of the scattered light 22 detected can be 0°-12° due to beam 14 and 90°-102° due to beam 16.

In a second embodiment, the angles detected due to beam 16 can be in the range 78°-89.9°. This embodiment can be accomplished by placing the detector array 24 to the right of the optical axis, rather than to the left as shown in FIG. 2. If the absorptive neutral-density filter 26 is used, then the angular range of the scattered light 22 detected due to beam 16 can be 78°-90°.

In a third embodiment, the detector array 24 can be oriented so that the detector elements form a line perpendicular to the plane defined by the paths of the two beams 14 and 16. In this embodiment, the polar angle, zero (0), detected due to scattering by beam 16 is always 90°, but the animuthal angle, Ø will be detected for Ø in the range from 0.1° to 12°. If a polarized light source is used, the scattering over a range of Ø can provide information about partical size. If the absorptive neutral-density filter 26 is used, then the azimuthal range of scattered light 22 detected due to beam 16 can be 0°-12°.

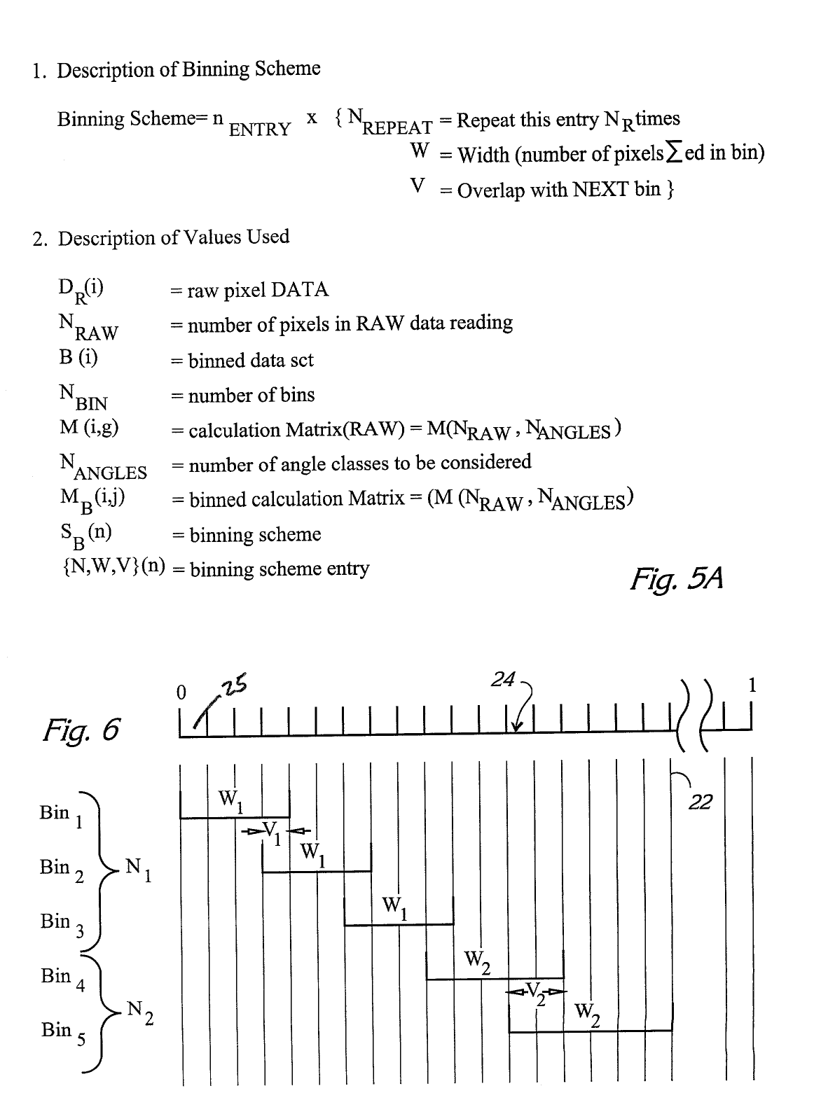

In an alternate embodiment, the two beams can intersect within an alternative sample cell 18′, at an angle that differs from 90° as shown in FIG. 3. In this arrangement, the sample cell provides a plurality of angled surfaces, such as in a hexagon or octagon, such that the direct beam 14 and the rerouted beam 16 intersect at 45 degrees or some other desired angle. Each of the beams 14 and 16 travels an equal distance through the cell 18′, in this case approximately 24.14 mm in the embodiment depicted in FIG. 3. The design shown is designed to minimize the effects of reflection and refraction from the walls of the sample cell 18 by ensuring that each beam is able to pass through two walls of the cell at right angles.

Because of the nature of light scattering by particles in the size range of interest, the simultaneous collection of light scattered at both small and wide angles provides data that can be used effectively to determine the particle size distribution over a wide range of particle sizes. If the sample 4 consists mostly of large particles, then the signals due to wide-angle diffraction from beam 16 will be negligibly small compared to those due to small angle scattering from beam 14. In spite of the approximate 55:1 ratio of excitation intensities, the small-angle scattering continues to play the primary role until the particles are very small (typically less than about one micron). If the sample 4 consists mostly of submicron particles, then wide-angle scattering from beam 16 will play a much more important role.

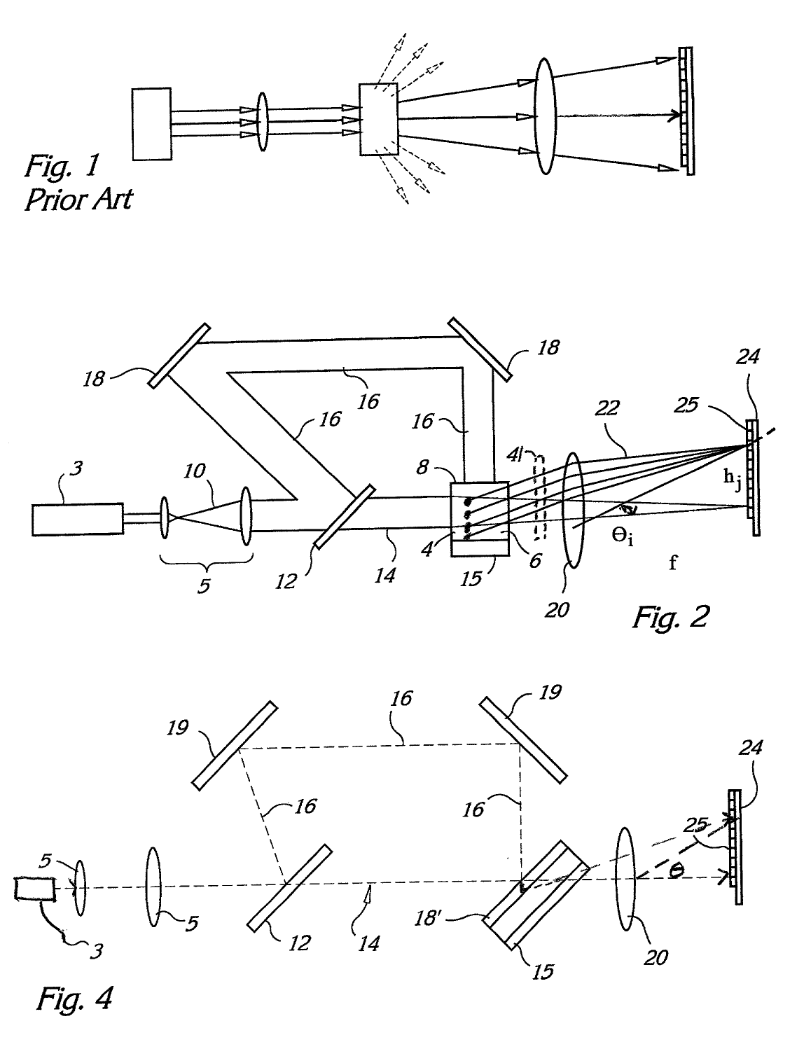

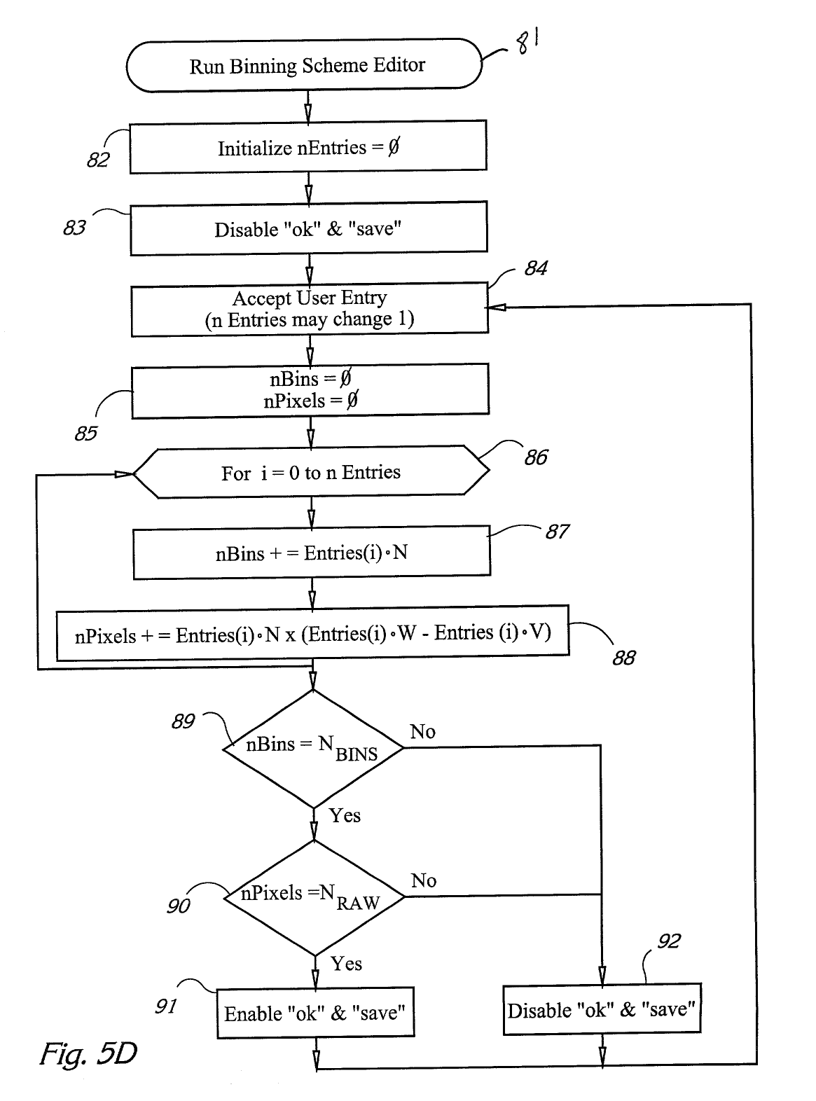

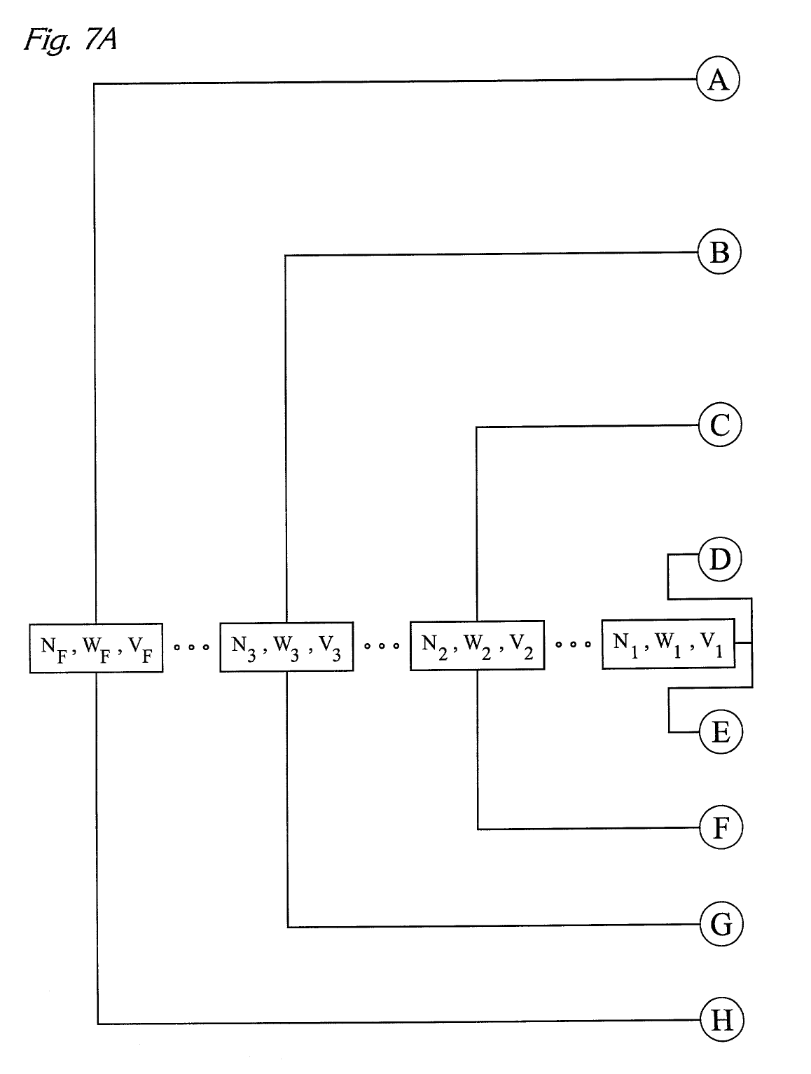

Once the data are collected, the software module 50 extracts an estimate of the relative quantities of particle sizes in the interrogated particles 4. This can be accomplished using, for example, a non-negative least squares (NNLS) fitting algorithm with the software 50 of the invention. The program 50 groups together some of the pixels so that their collective signal-to-noise ratio is larger. This can improve the precision within which the signal is measured. In the prior art, larger detectors at larger angles, as shown in FIG. 1, were employed to achieve this end. In the present invention, the software 50 accomplishes this by grouping, or binning, certain of the detector elements 25, or pixels, together as shown in FIGS. 6 and 7A, B. It is an object of this invention to provide software and a system 10 that permits individual users to create and/or modify these binning schemes in accordance with the most suitable scheme appropriate to the characteristics of the particles they wish to study. FIGS. 6, 7A and 7B illustrate the concept of the binning approach employed in the preferred embodiment of this invention.

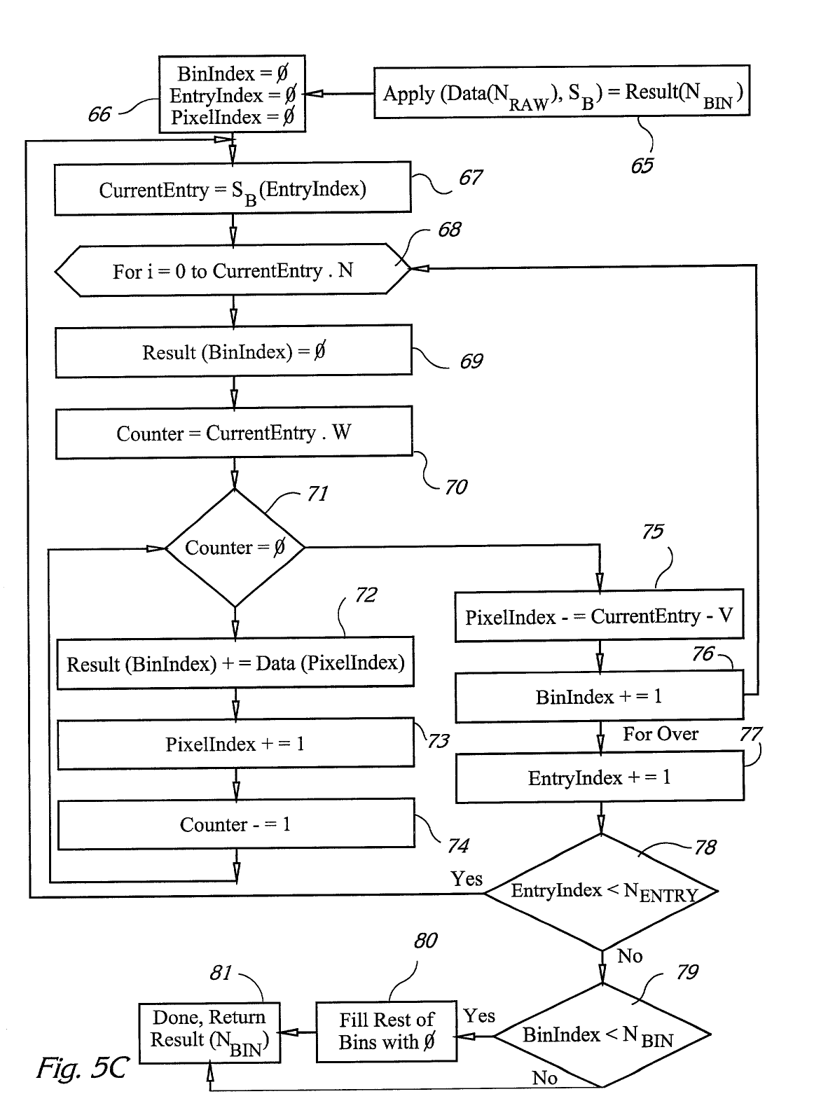

The software 50 comprises a set of processor readable instructions that control the detector and detector elements 24, 25 in accordance with operator input, as illustrated in FIGS. 5A-5D and FIGS. 7A-7B. The software 50 receives and loads the raw data, binning scheme and calculation matrix and applies the desired binning to the raw data for 0 to N-Angles and binning to matrix row and performs distribution calculations (52-64). The data is then applied to achieve a result in accordance with the iterations (65-81), as shown in FIG. 5C. The binning scheme is processed by the editor in steps 82-92 of FIG. 5D.

In accordance with the software 50, the user may specify one or more sets of bins. The number of bins in a particular set is denoted as N₁. Each of these N₁, bins has a user-selected bin width, W₁, and bin overlap, V₁. As a result, each set of data bins will consist of N₁* (W₁V₁)+V₁ pixels, with the value of each of the N₁, bins equal to the average of W₁ pixels. The corresponding matrix bins will be constructed from N₁*(W₁−V₁)+V₁ rows, each row having D Columns, where D is the number of particle sizes to be obtained from the analysis. The value of each bin equals the average of W₁ matrix elements within that column; that is there will be N₁*D bins. The definitions of the variables are set forth in FIG. 5A.

The user may specify N₁=5, W₁=8, and V₁+1. Then pixel 1 through pixel 36 will be used, as well as the first 36 rows of the model matrix. Data bin 1 will be equal to the average of pixels 1-8, data bin 2 will be equal to the average of pixels 8-15, data bin 3 will be equal to the average of pixels 15-22, data bin 4 will be equal to the average of pixels 22-29, and data bin 5 will be equal to the average of pixels 29-36. The first five rows of the binned matrix will be similarly constructed from the first 36 rows of the unbinned model matrix, each column of the matrix being treated separately from the other columns.

If the user then specifies, for example, N₂=4, W₁=16, and V₁=2, then pixels 37-94 and unbinned matrix rows 37 through 94 will be used to create data bins 6 through 9 and matrix bins 6 through 9. Data bin 6 will be equal to the average of pixels 37-52, data bin 7 will be equal to the average of pixels 51-66, data bin 8 will be equal to the average of pixels 65-80, and data bin 9 will be equal to the average of pixels 79-94. Rows 6 through 9 of the binned matrix will be similarly constructed from rows 37 through 94 of the unbinned model matrix, each column of the matrix being treated separately from the other columns.

The binning procedure 50 continues until all the pixels and matrix rows have been transferred into the binned data and binned matrix, respectively. The end result of the binning process is a set of binned data consisting of ΣN₁ values, where ΣN₁, is less than or equal to the number of values contained in the original data set, and a binned matrix consisting of ΣN₁, rows, but with the same number of columns as the original model matrix. The data and the model matrix may thus be reduced from, for example, 1024 data elements and 102,400 matrix elements (1024 rows and 100 columns), respectively, to 200 data elements and 20,000.00 matrix elements (200 rows and 100 columns) as shown in FIG. 7. Besides helping to improve the precision of the measurement, this approach can also reduce the time required to obtain the result, since the number of calculations required is roughly proportional to the number of rows in the binned matrix. In the above example, the calculation time could be reduced by a factor in the order of five.

The degaussing coil consists of a pair of magnets that encircle a portion of the particle's flow path. This may consist of a single annular-like magnet.

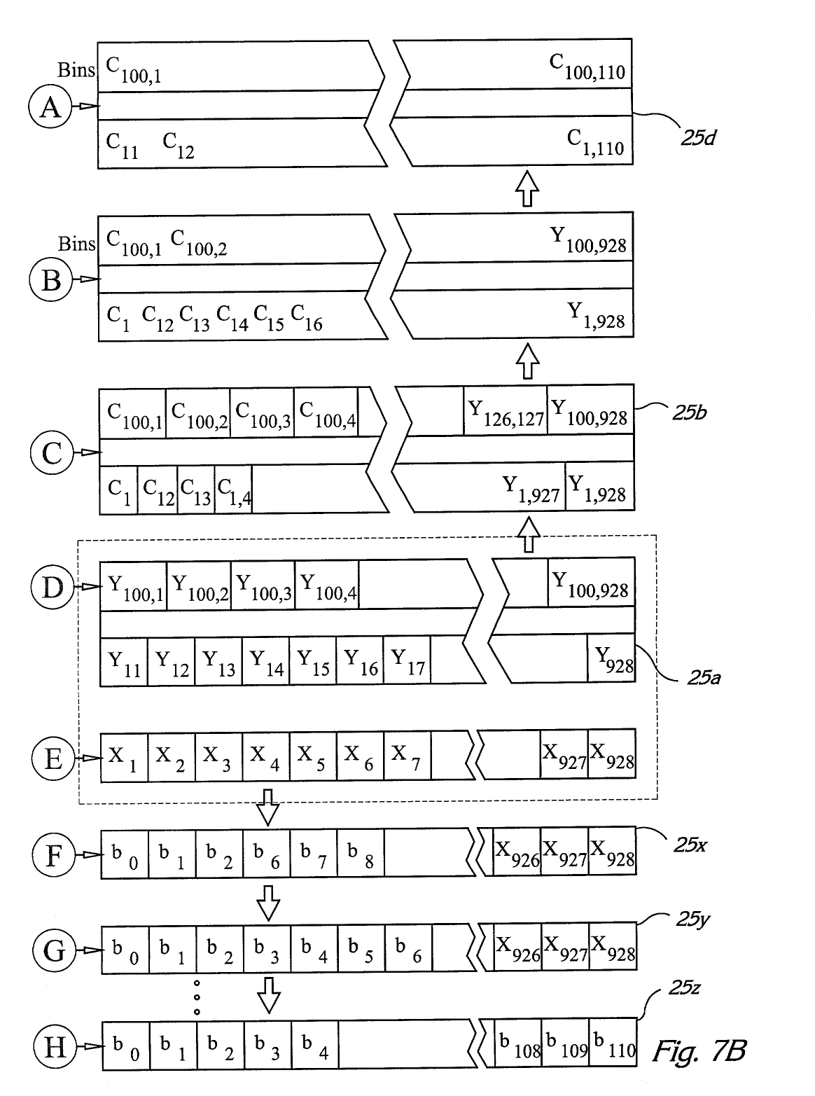

With reference to FIG. 8, for measuring the distribution of diameters in a sample composed of elongated particles such as fibers, a system may be used in the average of the smaller two dimensions may be measured. This can be achieved by modifying the sample cell in the embodiment of the invention discussed earlier. The modification consists of replacing the liquid flow cell with a thin, circular piece of glass, such as microscope glass, which may be mounted in a rotation state, such as that marketed by Thorlabs as part no. RSP1. The fibrous material is deposited onto the glass by the user, and held in place there by the addition of a circular cover glass. The assembly of the two pieces of glass and the sample is then held within the beam by the modified sample holder 18. The assembly is then rotated about an axis parallel to the optical axis as seen in FIG. 4. Then can be accomplished by, for example, a stepper motor synchronized with the data acquisition electronics of the instrument. As the sample assembly is rotated, the angle of revolution is determined and a light intensity reading is taken at that rotation angle. The assembly must be rotated through at least 180°. Rotating the sample holder through at least 180° will rotate the diffraction pattern through at least 180°, allowing all fiber orientations to scatter light on the detector 24. This will eliminate biases due to small fibers which scatter light at wide angles.

Because the samples are highly anisotropic in shape, the scattering pattern from each fiber will take the form of a single strip of alternating dark and bright regions, in contrast to the alternating dark and bright regions, in contrast to the alternating bright and dark annuli which result from diffraction by a spherical particle. Diffraction due to the long dimension of the fiber will be concentrated within a narrow range of angles near 0°. Since the fibers may be randomly oriented on the surface of the glass, the observed scattering pattern will appear as a large number of annular segments, each segment containing bright and dark regions corresponding to the diameter of the fiber producing that segment. In the case of a sample consisting of fibers with precisely the same diameter, the scattering pattern would appear as alternating bright and dark rings, similar to that produced by a sample composed of identical spherical particles. In the more common case of a sample composed of fibers with several different diameters, the diffraction pattern will be more complex.

The rotation about the optical axis is necessary to obtain information about all the particles being interrogated by the beam, since the rotation of the sample cell 18 also rotates the diffraction pattern. Doing so will bring half of the entire diffraction pattern, which can possess a strong azimuthal dependence if the fibers are not oriented completely at random, into the active area of the linear photo detector array. Only 180° of rotation is necessary, since the other half of the diffraction pattern is the mirror image of the first half.

Once the data acquisition is complete for each of several rotation angles up to 180° apart, the data for all the rotation angles are summed together as shown in the program 50. The calculation of the fiber diameters then proceeds in the same manner described in the embodiment that applies to flowing particles.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

We claim the following:

1. A system for measuring the particle size distributions of a sample occupying a sample volume, said system comprising:
light source means for receiving a light beam used in illuminating the sample volume;
means, in communication with said light source means, for splitting the light beam into at least two light beams, said two light beams comprising a first light beam and a second light beam;
means for impinging the sample volume with said first and second light beams along non-parallel paths such that said first and second light beams intersect in the sample volume and are scattered simultaneously by said particles as scattered light;
optical component means for collecting the scattered light and for detecting the intensity of the light scattered by the sample.

2. A system as recited in claim 1, wherein said optical means comprises:
a set of processor readable instructions that controls the reading of the scattered light in pre-selected groupings.

3. A system as recited in claim 1, wherein said optical means comprises:
a photodetector capable of measuring the scattered light in groups, said photodector having a means for communicating with a processor based machine.

4. A system as recited in claim 3, wherein said optical means comprises:
a photodetector in communication with said set of instructions, said set of instructions selecting predetermined groupings of the photodetector for measuring the scattered light in groups.

5. A system as recited in claim 1, wherein said first and second beams have intensities that differ in accordance with a predetermined ratio.

6. A system as recited in claim 1, wherein said impinging means comprises:
at least one mirror for directing said second beam into the sample volume at an angle that intersects with said first beam in the sample volume.

7. A system as recited in claim 6, wherein said splitting means generates said second beam such that it is approximately fifty times more intense than said first beam.

8. A system as recited in claim 7, wherein said impinging means directs said first and second beams into the sample volume at angles that are approximately ninety degrees apart.

9. A system as recited in claim 1, further comprising:
a degaussing coil that encircles a portion of the light beam's flow path to aid in dispersing magnetized particles.

10. A system as recited in claim 1, further comprising:
a sample cell for holding the sample, said sample cell providing the sample volume.

11. A system according to claim 10, wherein said sample cell comprises a plurality of planar windows oriented in a manner that permits said first and second beams to enter and exit the cell in a direction substantially perpendicular to the plane of said windows.

12. A system according to claim 1, wherein said first and second light beams have two or more electric field polarizations that are scattered simultaneously by said particles.

13. A system according to claim 4, measured photodetector values are shared by at least two data channels.

14. A system according to claim 3, wherein said set of processor readable steps receives and processes user inputs that selects said groups.

15. A system according to claim 4, wherein said detector comprises a plurality of detectors that can capture a plurality of ranges of scattering angles.

16. A system according to claim 1, wherein said detector captures a range of polarization angles at a particular scattering angle, in addition to capturing a range of scattering angles.

17. A system as recited in claim 1, further comprising:
means for rotating the sample to be examined.

18. A system according to claim 1, wherein said first and second light beams have different wavelengths.

19. A system according to claim 1, further comprising:
an attenuating filter for modifying the scattered light to a level that may be measured without saturating the detectors.

20. A system according to claim 1, wherein:
said means for splitting comprises a beam splitter that produces said first and second light beams at different intensities; and
said means for impinging comprises two mirrors oriented for receiving and directing one of said two light beams into the sample volume such that said first and second light beams intersect in the sample volume.
